(19) United States
(12) Patent Application Publication
(10) Pub. No.: US 2025/0156249 A1
(43) Pub. Date: May 15, 2025

(54) MONITORING AN APPLICATION PROGRAMMING INTERFACE FUNCTION AND ADJUSTING THE SAME

(71) Applicant: Capital One Services, LLC, McLean, VA (US)

(72) Inventors: Matthew Louis NOWAK, Midlothian, VA (US); Mohamed SECK, Aubrey, TX (US); Krystan R. FRANZEN, Mechanicsville, VA (US)

(21) Appl. No.: 18/508,006

(22) Filed: Nov. 13, 2023

(51) Int. Cl. G06F 9/54

(52) U.S. Cl. CPC G06F 9/541

(57) ABSTRACT

In some implementations, an application programming interface (API) monitor may provide traffic information associated with an API function to a machine learning model. The API monitor may determine, based on output from the machine learning model, whether the API function complies with one or more requirements in a service level agreement associated with the API function. Accordingly, the API monitor may transmit, to an administrator device, a report indicating whether the API function complies with the one or more requirements.

### BACKGROUND

Application programming interfaces (APIs) allow computer programs to communicate with each other. For example, one piece of software may call an API function provisioned by another piece of software. An API function may be provided in accordance with a service level agreement (SLA) between an entity that owns (or at least manages) the API function and an entity that accesses the API function.

### SUMMARY

Some implementations described herein relate to a system for monitoring and adjusting an API function. The system may include one or more memories and one or more processors communicatively coupled to the one or more memories. The one or more processors may be configured to provide traffic information associated with the API function to a machine learning model. The one or more processors may be configured to determine, based on output from the machine learning model, whether the API function complies with one or more requirements in an SLA associated with the API function. The one or more processors may be configured to transmit, to an administrator device, a report indicating whether the API function complies with the one or more requirements. The one or more processors may be configured to receive, from the machine learning model, an indication that the API function is predicted to fail. The one or more processors may be configured to transmit an instruction to scale the API function based on the indication that the API function is predicted to fail.

Some implementations described herein relate to a method of monitoring and adjusting an API function. The method may include providing, by an API monitor, traffic information associated with the API function to a machine learning model. The method may include receiving, from the machine learning model, an indication of at least one source that is abusing the API function. The method may include transmitting, to an administrator device, the indication of the at least one source. The method may include transmitting, based on the indication of the at least one source and to the API function, an instruction to block calls from the at least one source.

Some implementations described herein relate to a non-transitory computer-readable medium that stores a set of instructions for monitoring and adjusting an API function. The set of instructions, when executed by one or more processors of a device, may cause the device to provide traffic information associated with the API function to a machine learning model. The set of instructions, when executed by one or more processors of the device, may cause the device to determine, based on output from the machine learning model, whether the API function complies with one or more requirements in an SLA associated with the API function. The set of instructions, when executed by one or more processors of the device, may cause the device to transmit, to an administrator device, a report indicating whether the API function complies with the one or more requirements.

### BRIEF DESCRIPTION OF THE DRAWINGS

FIGS. 1A-1F are diagrams of an example implementation relating to monitoring an API function and adjusting the same, in accordance with some embodiments of the present disclosure.

FIG. 2 is a diagram of an example user interface associated with health of an API function, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to monitoring an API function and adjusting the same, in accordance with some embodiments of the present disclosure.

### DETAILED DESCRIPTION

The following detailed description of example implementations refers to the accompanying drawings. The same reference numbers in different drawings may identify the same or similar elements.

An application programming interface (API) function may be provided in accordance with a service level agreement (SLA). For example, the SLA may indicate an acceptable threshold that a latency of the API function should satisfy. In another example, the SLA may indicate a level of traffic (e.g., a quantity of calls and/or an average packet size associated with inputs) that the API function should accept. In order to determine compliance with an SLA, mathematical analysis may be conducted on logs associated with the API function. Such analysis consumes a significant amount of power, processing resources, and memory overhead.

Furthermore, problems with the API function often go unnoticed until the API function fails. Failure of the API function wastes power and processing resources on diagnostics and recovery and increases latency for users of the API function.

Some implementations described herein enable a machine learning model that tracks health of an API function. Using the machine learning model is both faster and more efficient (e.g., consuming less power and fewer processing resources) as compared with processing hundreds or thousands of log files associated with the API function. Additionally, the machine learning model may predict failure of the API function (e.g., when the API function is likely to crash or otherwise cause a problem or issue). As a result, an administrator may prevent failure of the API function, which conserves power and processing resources that otherwise would have been spent on diagnostics and recovery (and decreases latency for users of the API function that would have been caused by the failure). In some implementations, the machine learning model may trigger an autoscaling of the API function to compensate for heavy traffic, throttle the API function to prevent crashing, and/or otherwise prevent a denial-of-service (DOS) attack.

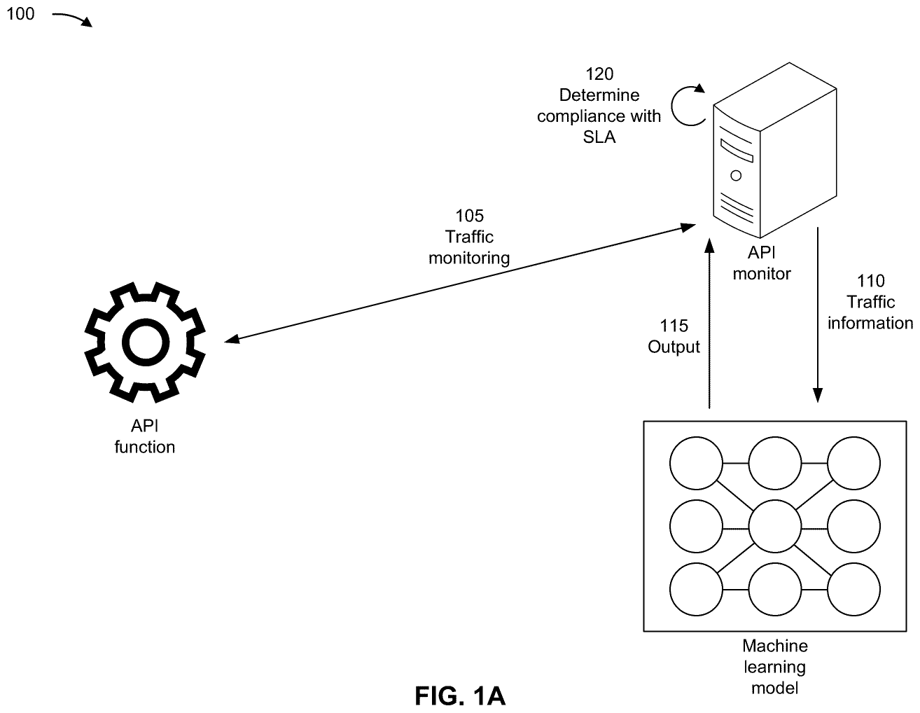

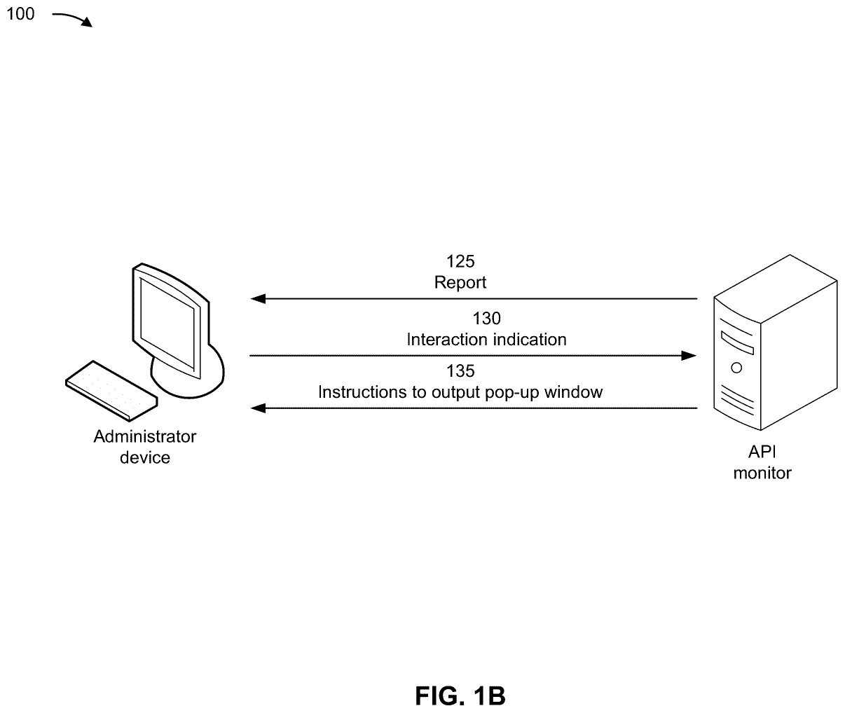

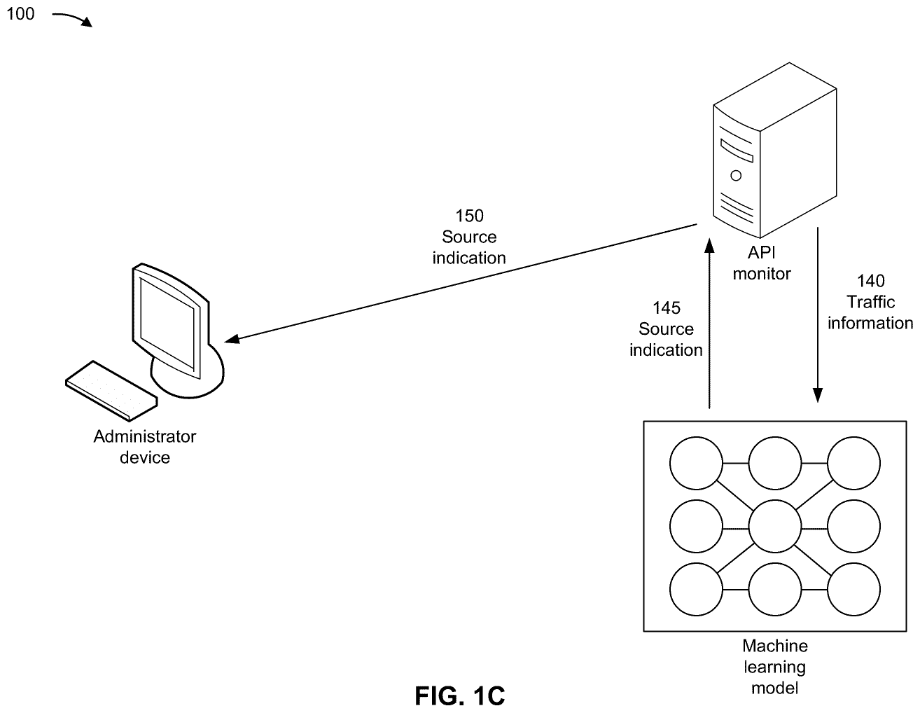

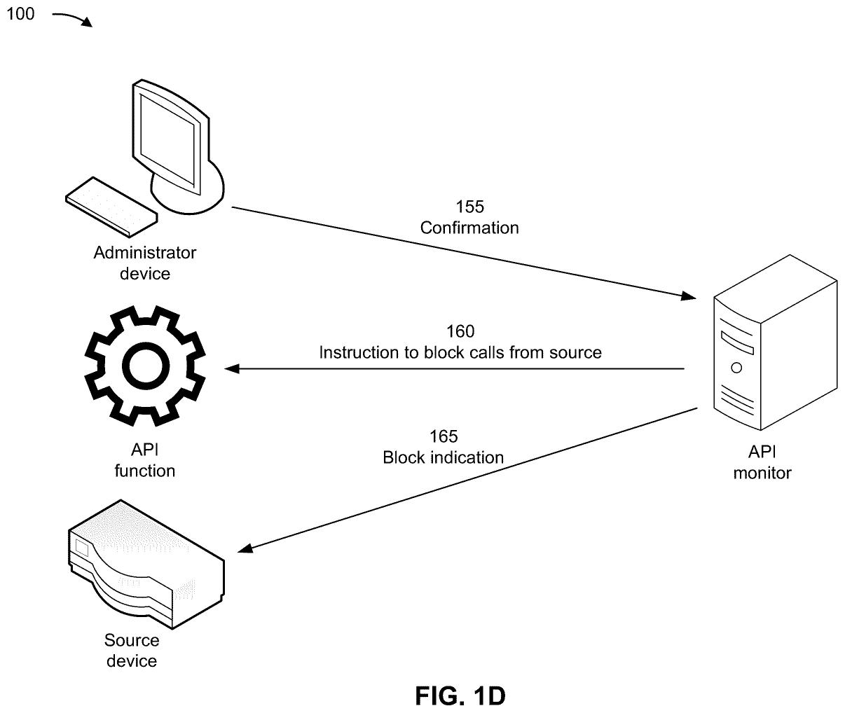

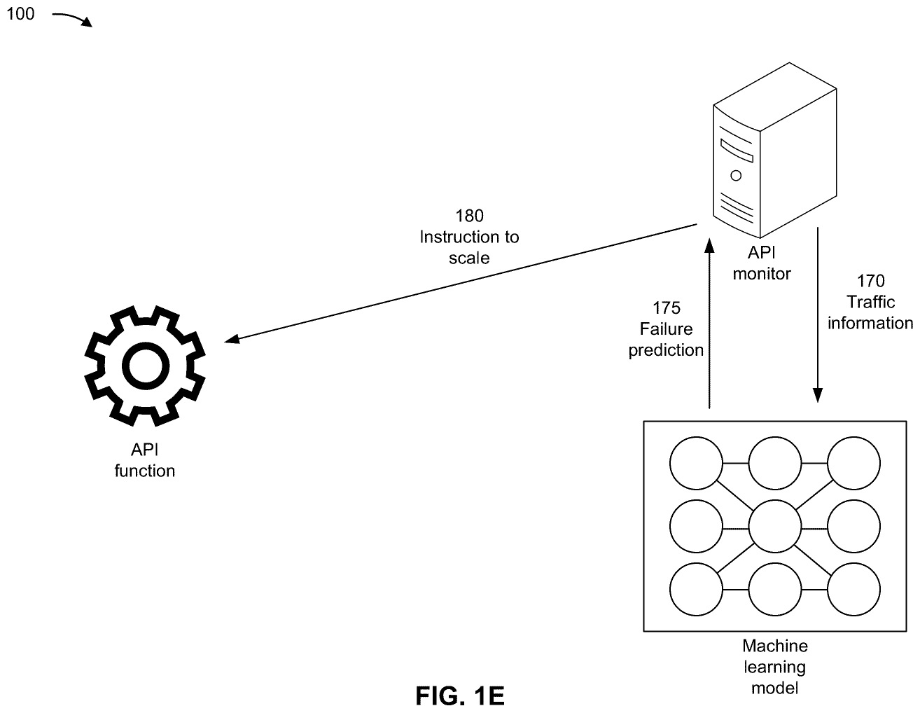

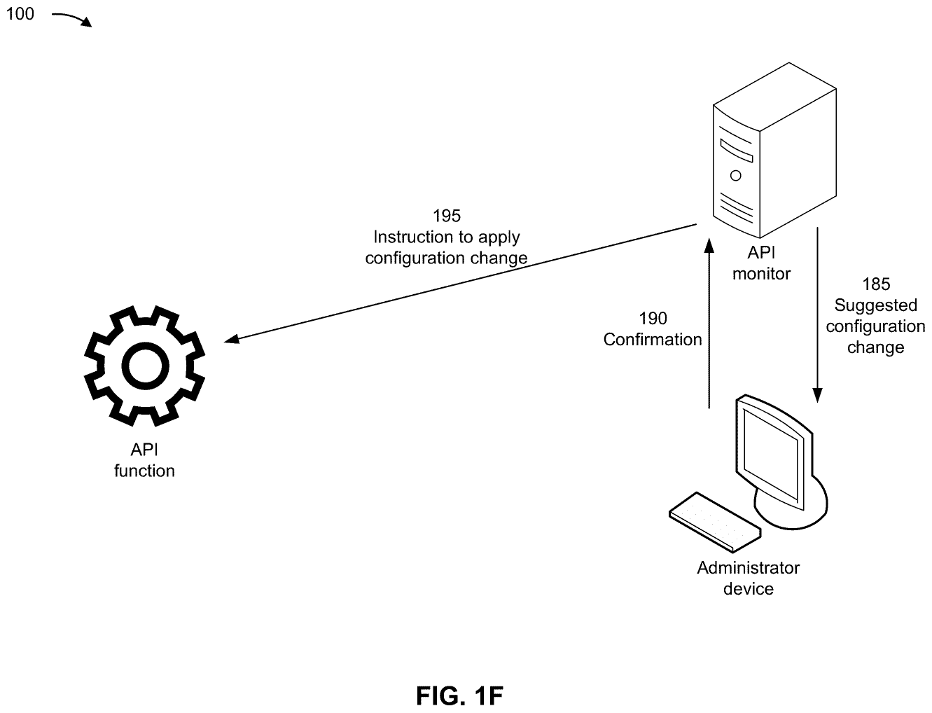

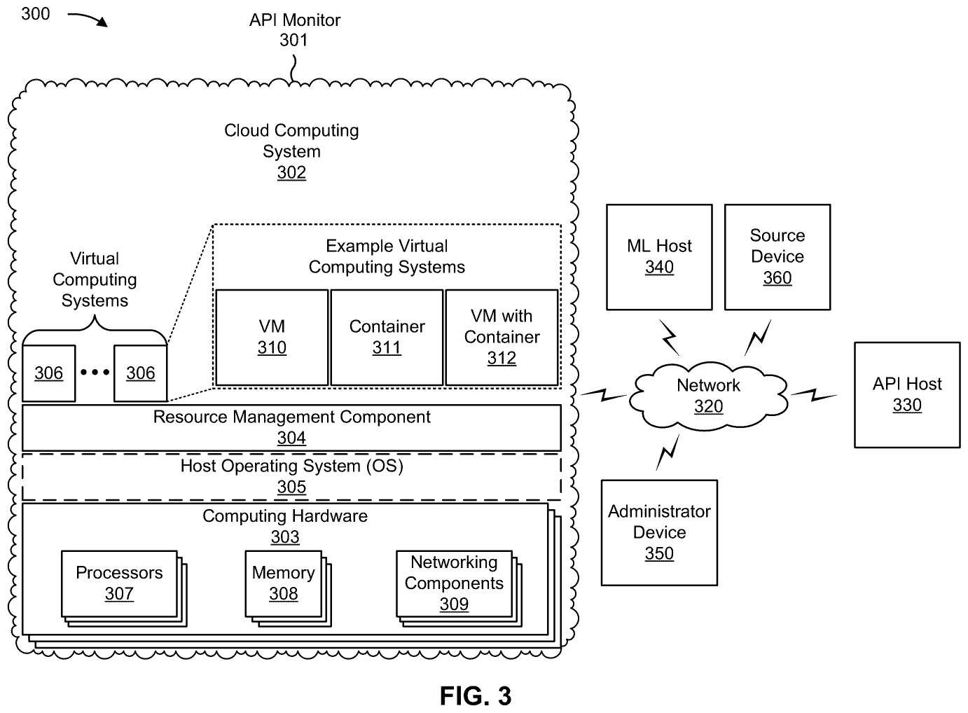

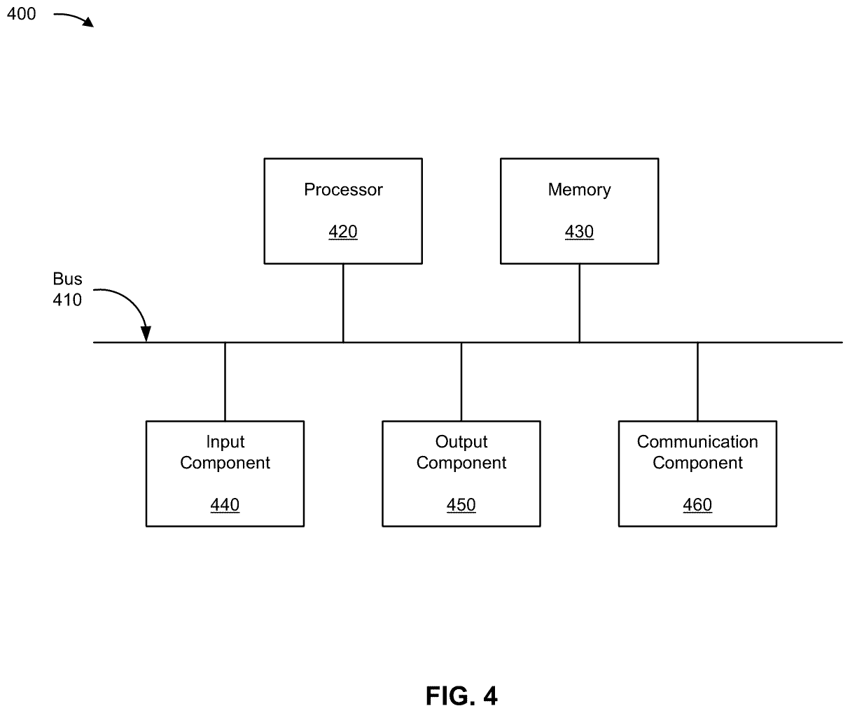

FIGS. 1A-1F are diagrams of an example 100 associated with monitoring an API function and adjusting the same. As shown in FIGS. 1A-1F, example 100 includes an API function (e.g., provided by an API host), an API monitor, a machine learning (ML) model (e.g., provided by an ML host), an administrator device, and a source device. These devices are described in more detail in connection with FIGS. 3 and 4.

As shown in FIG. 1A and by reference number 105, the API monitor may monitor traffic associated with the API function. In some implementations, the API function may be configured to transmit traffic information (e.g., periodically according to a schedule, pushed as available, and/or transmitted upon request) to the API monitor. The API monitor may subscribe to the traffic information and/or may configure the API function to transmit the traffic information to the API monitor. Additionally, or alternatively, the API monitor may receive log files (e.g., periodically according to a schedule, pulled as available, and/or received by request) generated by the API function. For example, the API monitor may subscribe to the log files and/or may configure a storage (e.g., integrated with the API host or at least partially separate from the API host) to transmit the log files to the API monitor.

As shown by reference number 110, the API monitor may provide, to the machine learning model, traffic information associated with the API function. The traffic information may include direct measurements (e.g., indications of sources associated with inputs to the API function, among other examples) and/or derived measurements (e.g., an average packet size associated with inputs to the API function and/or an average response time associated with the API function, among other examples).

The machine learning model may be trained (e.g., by the ML host and/or a device at least partially separate from the ML host) using a dataset labeled according to requirements (e.g., one or more requirements) in an SLA associated with the API function. Accordingly, the machine learning model may be configured to verify API functions against the SLA. In some implementations, the model may include a regression algorithm (e.g., linear regression or logistic regression), which may include a regularized regression algorithm (e.g., Lasso regression, Ridge regression, or Elastic-Net regression). Additionally, or alternatively, the model may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the dataset labeled according to the requirements in the SLA). For example, for a regression algorithm, a model parameter may include a regression coefficient (e.g., a weight). For a decision tree algorithm, a model parameter may include a decision tree split location, as an example.

Additionally, the ML host may use one or more hyperparameter sets to tune the model. A hyperparameter may include a structural parameter that controls execution of a machine learning algorithm, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm. In some implementations, the model may be a clustering model that groups similar API functions together. Accordingly, the machine learning model may determine compliance of the API function with the SLA based on a classification associated with a cluster that includes the API function.

As shown by reference number 115, the machine learning model may provide, to the API monitor, output (e.g., based on applying the traffic information from the API monitor to the machine learning model). The output may include an indication (e.g., a binary indicator, such as a bit or a Boolean) of whether the API function is compliant with the requirements in the SLA. Additionally, or alternatively, the output may include a plurality of indications (e.g., binary indicators), where each indication is associated with whether the API function is compliant with a different requirement in the SLA. Additionally, or alternatively, the output may include derived statistics associated with the API function (e.g., an average packet size and/or an average response time, among other examples) from which compliance may be determined. For example, the requirements in the SLA may include a threshold (e.g., one or more thresholds) associated with input to, or output from, the API function. Therefore, compliance may be determined based on whether the output from the machine learning model satisfies the threshold.

By using the machine learning model, the API monitor conserves power, processing resources, and memory overhead as compared with processing a large quantity of log files generated by the API function. In some implementations, the API function may feed the traffic information to the API monitor (e.g., periodically or on-demand) such that the machine learning model may monitor health of the API function more regularly than if the API monitor were to digest log files every so often.

Accordingly, as shown by reference number 120, the API monitor may determine, based on the output from the machine learning model, whether the API function complies with the requirements in the SLA associated with the API function. In one example, the API monitor may determine compliance using an indication of compliance output by the machine learning model. Additionally, or alternatively, the API monitor may determine compliance using a plurality of indications output by the machine learning model. For example, the API monitor may combine indications associated with independent requirements in the SLA using an “AND” operation, may combine indications associated with alternative requirements in the SLA using an “OR” operation, and/or may discard indications associated with optional requirements in the SLA. Additionally, or alternatively, the API monitor may determine compliance using a measurement (e.g., one or more measurements) output by the machine learning model. For example, the API monitor may determine compliance when the measurement satisfies a threshold indicated by the SLA and may determine non-compliance when the measurement fails to satisfy the threshold indicated by the SLA.

Although the example 100 is described in connection with the machine learning model being hosted separately from the API monitor, other examples may include the machine learning model being at least partially integrated (e.g., physically, logically, and/or virtually) with the API monitor. Additionally, or alternatively, other examples may include the machine learning model being at least partially integrated (e.g., physically, logically, and/or virtually) with the API host. In one example, the API monitor, the API function, and the machine learning model may all be at least partially integrated into a single device (or a collaborative system of devices).

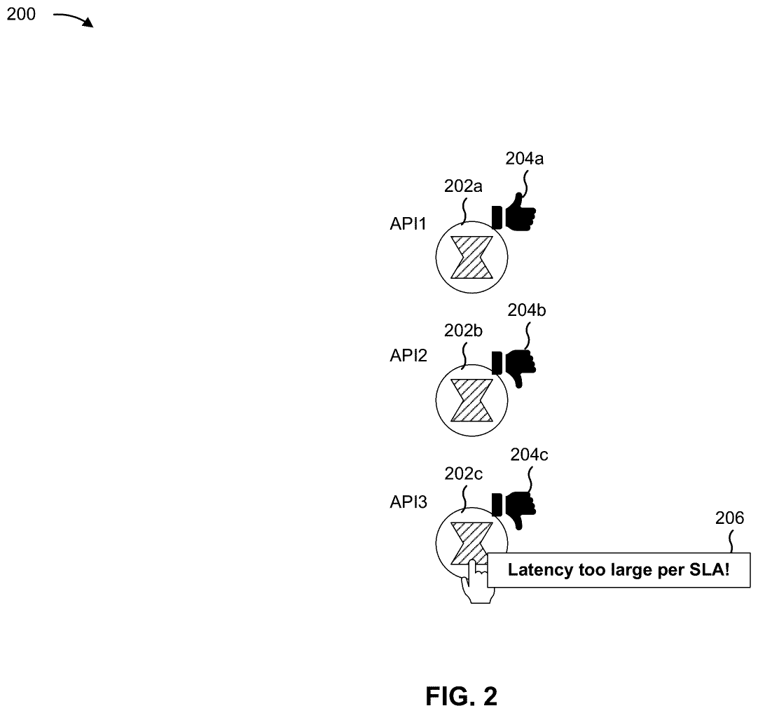

As shown in FIG. 1B and by reference number 125, the API monitor may transmit, and the administrator device may receive, a report indicating whether the API function complies with the requirements. For example, the report may include a file (e.g., a portable document format (pdf) file, among other examples) encoding an indication of whether the API function complies with the requirements. The indication may include text and/or a graphic (e.g., a “thumbs up” or a “thumbs down,” as shown in FIG. 2). In another example, the report may include instructions to output a user interface (UI), the UI including a visual indicator, associated with the API function, that indicates whether the API function complies with the requirements. The report may additionally include (e.g., in the file and/or the UI) a reason why the API function is non-compliant (e.g., as described in connection with FIG. 2).

In some implementations, as shown by reference number 130, the administrator device may transmit, and the API monitor may receive, an indication of an interaction with the visual indicator. For example, a user of the administrator device (e.g., an administrator associated with the API function) may hover, click, tap, speak, and/or otherwise interact (e.g., using an input component of the administrator device) with the UI (e.g., output using an output component of the administrator device). Accordingly, as shown by reference number 135, the API monitor may transmit, and the administrator device may receive, instructions to output a pop-up window including information associated with the requirements. For example, the pop-up window may include a reason why the API function is non-compliant with the requirements, as described in connection with FIG. 2.

In some implementations, the API monitor may transmit, and the API host associated with the API function may receive, a command to disable the API function. For example, the API monitor may determine to disable the API function based on whether the API function complies with the requirements. When the API function is non-compliant (or is non-compliant with a quantity of requirements that satisfies a disabling threshold), the API monitor may determine to disable the API function for repairs. Additionally, or alternatively, the administrator device may transmit, and the API monitor may receive, an instruction to disable the API function in response to the report. For example, a user of the administrator device (e.g., an administrator associated with the API function) may interact with an input component of the administrator device in order to trigger the administrator device to transmit the instruction. Accordingly, the API monitor may transmit the command to the API host in response to receiving the instruction from the administrator device.

Additionally with, or alternatively to, determining compliance with the SLA, the API monitor may determine whether a source is abusing the API function. As shown in FIG. 1C and by reference number 140, the API monitor may provide, to a machine learning model, traffic information associated with the API function. As described above, the traffic information may include direct measurements (e.g., indications of sources associated with inputs to the API function, among other examples) and/or derived measurements (e.g., an average packet size associated with inputs to the API function and/or an average response time associated with the API function, among other examples).

The machine learning model may be trained (e.g., by the ML host and/or a device at least partially separate from the ML host) using a dataset associated with DOS attacks. Accordingly, the machine learning model may be configured to detect abuse of the API function (e.g., based on a rate of inputs to the API function and/or a size associated with the inputs, among other examples). The machine learning model may be the same model as is described above and is used to determine compliance with the SLA. Alternatively, a model ensemble may include one machine learning model that determines compliance with the SLA and another machine learning model that detects abuse. Alternatively, the machine learning model that determines compliance with the SLA may be fully separate (e.g., separately trained and/or separately deployed) from the machine learning model that detects abuse.

As shown by reference number 145, the machine learning model may output, and the API monitor may receive, an indication of a source (e.g., at least one source) that is abusing the API function. For example, the indication may include an Internet protocol (IP) address and/or a source name, among other examples. The source may be abusing the API function by performing too many calls (e.g., transmitting too many requests) to the API function within a time window (e.g., a period of time, whether sliding or stationary). Additionally, or alternatively, the source may be abusing the API function by transmitting requests that are too large (e.g., on average or in bursts, among other examples).

As shown by reference number 150, the API monitor may transmit, and the administrator device may receive, the indication of the source. The API monitor may transmit a file and/or instructions to output a UI, which encodes the indication. As shown in FIG. 1D and by reference number 155, the administrator device may transmit, and the API monitor may receive, a confirmation in response to the indication of the source. For example, a user of the administrator device (e.g., an administrator associated with the API function) may interact with an input component of the administrator device in order to trigger the administrator device to transmit the confirmation.

As shown by reference number 160, the API monitor may transmit, and the API function may receive, an instruction to block calls from the source. The API monitor may transmit the instruction based on the indication of the source. For example, the API monitor may automatically transmit the instruction in response to receiving the indication of the source from the machine learning model. Alternatively, the API monitor may transmit the instruction in response to the confirmation from the administrator device. The instruction may include a configuration (e.g., encoded in a file), such as a blacklist that includes the abusive source or a modified whitelist that excludes the abusive source, for the API function to apply. Additionally, or alternatively, the instruction may include a command to the API host, such that the API host modifies the API function (and/or a configuration thereof) accordingly.

By blocking the source proactively, the API monitor may prevent abuse of the API function or even an attack on the API function (e.g., a DOS attack). As a result, the API monitor conserves power and processing resources that otherwise would have been spent on diagnostics and recovery (and decreases latency for users of the API function that would have been caused by the abuse or attack).

In some implementations, as shown by reference number 165, the API monitor may transmit, and the source device (e.g., associated with the source via an IP address or another indication) may receive, an indication that the source is blocked. The indication may include an email message, a text message, a push notification, and/or a hypertext transmit protocol (HTTP) response, among other examples.

Additionally with, or alternatively to, determining compliance with the SLA and/or whether a source is abusing the API function, the API monitor may autoscale the API function. As shown in FIG. 1E and by reference number 170, the API monitor may provide, to a machine learning model, traffic information associated with the API function. As described above, the traffic information may include direct measurements (e.g., indications of sources associated with inputs to the API function, among other examples) and/or derived measurements (e.g., an average packet size associated with inputs to the API function and/or an average response time associated with the API function, among other examples).

The machine learning model may be trained (e.g., by the ML host and/or a device at least partially separate from the ML host) using a dataset labeled according to whether API functions failed. Accordingly, the machine learning model may be configured to predict whether the API function will fail (e.g., based on the traffic information associated with the API function). The machine learning model may be a same model as is described above and is used to determine compliance with the SLA and/or is used to detect abuse. Alternatively, a model ensemble may include one machine learning model that determines compliance with the SLA and/or detects abuse and another machine learning model that predicts failure. Alternatively, the machine learning model that determines compliance with the SLA and/or detects abuse may be fully separate (e.g., separately trained and/or separately deployed) from the machine learning model that predicts failure.

As shown by reference number 175, the machine learning model may output, and the API monitor may receive, an indication that the API function is predicted to fail. The indication may include a bit (or a Boolean) associated with a probability that the API function will fail satisfying a failure threshold. Additionally, or alternatively, the indication may include the probability, that the API function will fail, as calculated by the machine learning model. In some implementations, the indication may further include a future datetime. For example, the machine learning model may predict that a current trend in the traffic information (e.g., increasing spikes in calls to the API function on particular days and/or at particular times, among other examples) will result in failure of the API function at the future datetime.

As shown by reference number 180, the API monitor may transmit, and the API host associated with the API function may receive, an instruction to scale the API function. The API monitor may transmit the instruction based on the indication that the API function is predicted to fail. For example, the API monitor may automatically transmit the instruction in response to receiving the indication from the machine learning model. Alternatively, the API monitor may transmit the instruction in response to a confirmation from the administrator device (e.g., similarly as described above in connection with reference number 155). The instruction may indicate a quantity of instances of the API function that should be active (and/or a quantity of new instances of the API function that should be initialized). Additionally, or alternatively, the instruction may include a command to the API host, such that the API host initiates new instances of the API function accordingly.

In some implementations, the instruction to scale is further based on the traffic information. For example, based on a current trend in the traffic information, the machine learning model may output an indication of a predicted maximum for calls to the API function. Accordingly, the API monitor may determine a quantity of instances of the API function that are sufficient to handle the predicted maximum without failure. Therefore, the instruction to scale may indicate the quantity of instances based on the predicted maximum.

By autoscaling the API function, the API monitor may compensate for heavy traffic, which prevents failure of the API function. As a result, the API monitor conserves power and processing resources that otherwise would have been spent on diagnostics and recovery (and decreases latency for users of the API function that would have been caused by the failure). Additionally with, or alternatively to, determining compliance with the SLA, detecting abuse, and/or autoscaling the API function, the API monitor may adjust a configuration associated with the API function. As shown in FIG. 1F and by reference number 185, the API monitor may provide, to a machine learning model, traffic information associated with the API function. As described above, the traffic information may include direct measurements (e.g., indications of sources associated with inputs to the API function, among other examples) and/or derived measurements (e.g., an average packet size associated with inputs to the API function and/or an average response time associated with the API function, among other examples).

The machine learning model may be trained (e.g., by the ML host and/or a device at least partially separate from the ML host) using a dataset labeled according to configurations of API functions and the requirements in the SLA. Accordingly, the machine learning model may be configured to recommend a configuration for the API function (e.g., based on the traffic information associated with the API function). The machine learning model may be a same model as is described above and is used to determine compliance with the SLA, is used to detect abuse, and/or is used to predict failure. Alternatively, a model ensemble may include one machine learning model that determines compliance with the SLA, detects abuse, and/or predicts failure and another machine learning model that recommends configurations. Alternatively, the machine learning model that determines compliance with the SLA, detects abuse, and/or predicts failure may be fully separate (e.g., separately trained and/or separately deployed) from the machine learning model that recommends configurations.

As shown by reference number 190, the machine learning model may output, and the API monitor may receive, an indication of a suggested configuration change to the API function. In some implementations, the indication of the suggested configuration change is based on whether the API function complies with the requirements in the SLA. The suggested configuration change may include a rate limit (e.g., blocking a quantity of requests that satisfy a request threshold within a time window) and/or a response requirement (e.g., transmitting a failure indication when a response is not generated within an amount of time), among other examples.

As shown by reference number 195, the API monitor may transmit, and the API host associated with the API function may receive, an instruction to apply the suggested configuration change. The API monitor may transmit the instruction based on the indication of the suggested configuration change. For example, the API monitor may automatically transmit the instruction in response to receiving the indication from the machine learning model. Alternatively, the API monitor may transmit the instruction in response to an approval from the administrator device (e.g., similarly as described above in connection with reference number 155 with the administrator device transmitting a configuration).

By using techniques as described in connection with FIGS. 1A-1F, the API monitor uses a machine learning model to determine compliance of the API function with the SLA. Using the machine learning model is both faster and more efficient (e.g., consuming less power and fewer processing resources) as compared with processing hundreds or thousands of log files associated with the API function. Additionally, the API monitor may predict failure of the API function (e.g., when the API function is likely to crash or otherwise cause a problem or issue). As a result, the API monitor may prevent failure of the API function, which conserves power and processing resources that otherwise would have been spent on diagnostics and recovery (and decreases latency for users of the API function that would have been caused by the failure). In some implementations, the API monitor may autoscale the API function to compensate for heavy traffic, which prevents failure of the API function. As a result, the API monitor conserves power and processing resources that otherwise would have been spent on diagnostics and recovery (and decreases latency for users of the API function that would have been caused by the failure).

As indicated above, FIGS. 1A-1F are provided as an example. Other examples may differ from what is described with regard to FIGS. 1A-1F.

FIG. 2 is a diagram of an example UI 200 associated with health of an API function. The example UI 200 may be shown by an administrator device (e.g., based on instructions from an API monitor). These devices are described in more detail in connection with FIGS. 3 and 4.

As shown in FIG. 2, the example UI 200 includes visual indicators 202a, 202b, and 202c that are associated with different API functions (e.g., “API1,” “API2,” and “API3,” respectively, in the example UI 200). Additionally, the example UI 200 includes visual indicators 204a, 204b, and 204c of whether APIs are in compliance with requirements in an SLA. In FIG. 2, the visual indicator 204a is adjacent to the visual indicator 202a and thus is associated with a same API function as the visual indicator 202a. Similarly, the visual indicator 204b is adjacent to the visual indicator 202b and thus is associated with a same API function as the visual indicator 202b, and the visual indicator 204c is adjacent to the visual indicator 202c and thus is associated with a same API function as the visual indicator 202c.

As further shown in FIG. 2, a user may interact with the visual indicators. For example, the user may hover, click, tap, speak, or otherwise interact with the visual indicator 202c (and/or the visual indicator 204c associated therewith) to trigger a pop-up window 206. The pop-up window 206 indicates a reason that the API function associated with the visual indicator 202c (and thus with the visual indicator 204c) is non-compliant with the requirements in the SLA. In the example UI 200, a latency of the API function associated with the visual indicator 202c (and thus with the visual indicator 204c) fails to satisfy a latency threshold indicated in the SLA.

As indicated above, FIG. 2 is provided as an example. Other examples may differ from what is described with regard to FIG. 2. Other examples may include fewer API functions and thus fewer visual indicators or may include additional API functions and thus additional visual indicators. Additionally, or alternatively, other examples may include different non-compliance reasons indicated in the pop-up window 206.

FIG. 3 is a diagram of an example environment 300 in which systems and/or methods described herein may be implemented. As shown in FIG. 3, environment 300 may include a API monitor 301, which may include one or more elements of and/or may execute within a cloud computing system 302. The cloud computing system 302 may include one or more elements 303-312, as described in more detail below. As further shown in FIG. 3, environment 300 may include a network 320, an API host 330, an ML host 340, an administrator device 350, and/or a source device 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the API monitor 301 may include one or more elements 303-312 of the cloud computing system 302, may execute within the cloud computing system 302, and/or may be hosted within the cloud computing system 302, in some implementations, the API monitor 301 may not be cloud-based (e.g., may be implemented outside of a cloud computing system) or may be partially cloud-based. For example, the API monitor 301 may include one or more devices that are not part of the cloud computing system 302, such as device 400 of FIG. 4, which may include a standalone server or another type of computing device. The API monitor 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The API host 330 may include one or more devices capable of receiving, generating, storing, processing, providing, and/or routing information associated with API functions, as described elsewhere herein. The API host 330 may include a communication device and/or a computing device. For example, the API host 330 may include a server, such as an application server, a client server, a web server, a database server, a host server, a proxy server, a virtual server (e.g., executing on computing hardware), or a server in a cloud computing system. In some implementations, the API host 330 may include computing hardware used in a cloud computing environment. The API host 330 may communicate with one or more other devices of environment 300, as described elsewhere herein.

The ML host 340 may include one or more devices capable of receiving, generating, storing, processing, and/or providing information associated with machine learning models, as described elsewhere herein. The ML host 340 may include a communication device and/or a computing device. For example, the ML host 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 340 may communicate with one or more other devices of environment 300, as described elsewhere herein.

The administrator device 350 may include one or more devices capable of receiving, generating, storing, processing, and/or providing information associated with API functions, as described elsewhere herein. The administrator device 350 may include a communication device and/or a computing device. For example, the administrator device 350 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 350 may communicate with one or more other devices of environment 300, as described elsewhere herein.

The source device 360 may include one or more devices capable of receiving, generating, storing, processing, and/or providing information associated with API calls, as described elsewhere herein. The source device 360 may include a communication device and/or a computing device. For example, the source device 360 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. Additionally, or alternatively, the source device 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The source device 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with monitoring an API function and adjusting the same. The device 400 may correspond to an API host 330, an ML host 340, an administrator device 350, and/or a source device 360. In some implementations, an API host 330, an ML host 340, an administrator device 350, and/or a source device 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

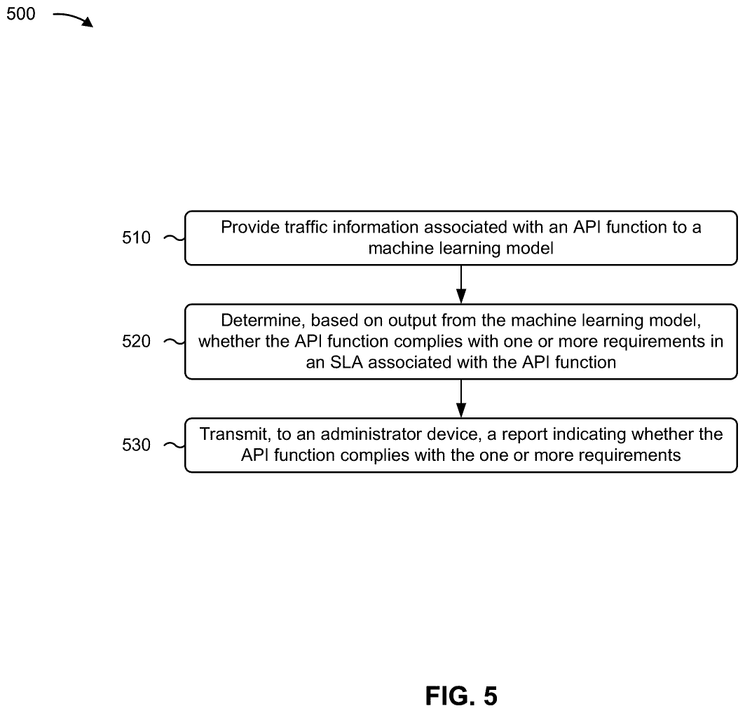

FIG. 5 is a flowchart of an example process 500 associated with monitoring an API function and adjusting the same. In some implementations, one or more process blocks of FIG. 5 may be performed by an API monitor 301. In some implementations, one or more process blocks of FIG. 5 may be performed by another device or a group of devices separate from or including the API monitor 301, such as an API host 330, an ML host 340, an administrator device 350, and/or a source device 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include providing traffic information associated with an API function to a machine learning model (block 510). For example, the API monitor 301 (e.g., using processor 420 and/or memory 430) may provide traffic information associated with the API function to a machine learning model, as described above in connection with reference number 110 of FIG. 1A. As an example, the API monitor 301 may transmit the traffic information to an ML host providing the machine learning model. The traffic information may include direct measurements (e.g., indications of sources associated with inputs to the API function, among other examples) and/or derived measurements (e.g., an average packet size associated with inputs to the API function and/or an average response time associated with the API function, among other examples).

As further shown in FIG. 5, process 500 may include determining, based on output from the machine learning model, whether the API function complies with one or more requirements in an SLA associated with the API function (block 520). For example, the API monitor 301 (e.g., using processor 420 and/or memory 430) may determine, based on output from the machine learning model, whether the API function complies with one or more requirements in an SLA associated with the API function, as described above in connection with reference number 120 of FIG. 1A. As an example, the output may include an indication of compliance, and the API monitor 301 may determine compliance using the indication of compliance. Additionally, or alternatively, the output may include a plurality of indications, and the API monitor 301 may determine compliance by combining the plurality of indications (e.g., combining indications associated with independent requirements in the SLA using an “AND” operation, combining indications associated with alternative requirements in the SLA using an “OR” operation, and/or discarding indications associated with optional requirements in the SLA). Additionally, or alternatively, the output may include one or more measurements, and the API monitor 301 may determine compliance using the one or more measurements (e.g., determining compliance when the one or more measurements satisfy a set of thresholds indicated by the SLA, and determining non-compliance when the one or more measurements fail to satisfy at least one threshold, in the set of thresholds, indicated by the SLA).

As further shown in FIG. 5, process 500 may include transmitting, to an administrator device, a report indicating whether the API function complies with the one or more requirements (block 530). For example, the API monitor 301 (e.g., using processor 420, memory 430, and/or communication component 460) may transmit, to an administrator device, a report indicating whether the API function complies with the one or more requirements, as described above in connection with reference number 125 of FIG. 1B. As an example, the report may include a file (e.g., a pdf file, among other examples) encoding an indication of whether the API function complies with the one or more requirements. The indication may include text and/or a graphic (e.g., a “thumbs up” or a “thumbs down,” as shown in FIG. 2). In another example, the report may include instructions to output a UI (e.g., as described in connection with FIG. 2).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for monitoring and adjusting an application programming interface (API) function, the system comprising:
one or more memories; and
one or more processors, communicatively coupled to the one or more memories, configured to:
provide traffic information associated with the API function to a machine learning model;
determine, based on output from the machine learning model, whether the API function complies with one or more requirements in a service level agreement (SLA) associated with the API function;
transmit, to an administrator device, a report indicating whether the API function complies with the one or more requirements;
receive, from the machine learning model, an indication that the API function is predicted to fail; and
transmit an instruction to scale the API function based on the indication that the API function is predicted to fail.

2. The system of claim 1, wherein the one or more processors are configured to:
receive, from the machine learning model, an indication of a suggested configuration change to the API function based on whether the API function complies with the one or more requirements; and
transmit an instruction to apply the suggested configuration change.

3. The system of claim 2, wherein the report indicates the suggested configuration change, and the one or more processors are configured to:
receive, from the administrator device, an approval of the suggested configuration change,
wherein the instruction to apply the suggested configuration change is transmitted in response to the approval.

4. The system of claim 1, wherein the traffic information indicates one or more sources associated with inputs to the API function, an average packet size associated with the inputs, or an average response time associated with the API function.

5. The system of claim 1, wherein the machine learning model is trained using a dataset labeled according to the one or more requirements in the SLA.

6. The system of claim 1, wherein the indication that the API function is predicted to fail includes a future datetime.

7. The system of claim 1, wherein the instruction to scale is further based on the traffic information.

8. A method of monitoring and adjusting an application programming interface (API) function, comprising:
providing, by an API monitor, traffic information associated with the API function to a machine learning model;
receiving, from the machine learning model, an indication of at least one source that is abusing the API function;
transmitting, to an administrator device, the indication of the at least one source; and
transmitting, based on the indication of the at least one source and to the API function, an instruction to block calls from the at least one source.

9. The method of claim 8, further comprising:
receiving, from the administrator device, a confirmation in response to the indication of the at least one source,
wherein the instruction to block calls is transmitted based on the confirmation.

10. The method of claim 8, wherein the indication of the at least one source includes an Internet protocol (IP) address, a source name, or a combination thereof.

11. The method of claim 8, wherein the machine learning model is configured to detect abuse of the API function based on a rate of inputs to the API function, a size associated with the inputs, or a combination thereof.

12. The method of claim 8, further comprising:
transmitting, to a device associated with the at least one source, an indication that the at least one source is blocked.

13. The method of claim 8, wherein the machine learning model is trained using a dataset associated with denial-of-service attacks.

14. A non-transitory computer-readable medium storing a set of instructions for monitoring and adjusting an application programming interface (API) function, the set of instructions comprising:
one or more instructions that, when executed by one or more processors of a device, cause the device to:
provide traffic information associated with the API function to a machine learning model;
determine, based on output from the machine learning model, whether the API function complies with one or more requirements in a service level agreement (SLA) associated with the API function; and
transmit, to an administrator device, a report indicating whether the API function complies with the one or more requirements.

15. The non-transitory computer-readable medium of claim 14, wherein the report comprises a file encoding an indication of whether the API function complies with the one or more requirements.

16. The non-transitory computer-readable medium of claim 14, wherein the report comprises instructions to output a user interface (UI), wherein the UI includes a visual indicator, associated with the API function, that indicates whether the API function complies with the one or more requirements.

17. The non-transitory computer-readable medium of claim 16, wherein the one or more instructions, when executed by the one or more processors, cause the device to:
receive, from the administrator device, an indication of an interaction with the visual indicator; and
transmit, to the administrator device, instructions to output a pop-up window including information associated with the one or more requirements.

18. The non-transitory computer-readable medium of claim 14, wherein the one or more requirements in the SLA include one or more thresholds associated with input to, or output from, the API function.

19. The non-transitory computer-readable medium of claim 14, wherein the one or more instructions, when executed by the one or more processors, cause the device to:
receive, from the administrator device, an instruction to disable the API function in response to the report; and
transmit, based on the instruction and to a host associated with the API function, a command to disable the API function.

20. The non-transitory computer-readable medium of claim 14, wherein the one or more instructions, when executed by the one or more processors, cause the device to:
transmit, based on whether the API function complies with the one or more requirements, a command to throttle the API function.
